(19) United States
(12) Patent Application Publication
(10) Pub. No.: US 2019/0248330 A1
(43) Pub. Date: Aug. 15, 2019

(54) VEHICULAR ON-BOARD DEVICE, PORTABLE DEVICE, AND WIRELESS COMMUNICATION SYSTEM FOR VEHICLES

(71) Applicant: Panasonic Intellectual Property Management Co., Ltd., Osaka (JP)

(72) Inventors: MOTOKI ASANO, Kanagawa (JP); MASAMI TAKIGAWA, Kanagawa (JP); NAOKI HAYASHI, Kanagawa (JP)

(21) Appl. No.: 16/336,717

(22) PCT Filed: Sep. 26, 2017
(86) PCT No.: PCT/JP2017/034609

§ 371 Date: Mar. 26, 2019

(30) Foreign Application Priority Data
Oct. 7, 2016 (JP) 2016-199463
Oct. 7, 2016 (JP) 2016-199464
Oct. 7, 2016 (JP) 2016-199465

(51) Int. Cl. B60R 25/24; G06F 21/44; H04W 12/00; H04W 12/06; B60R 25/20

(52) U.S. Cl. CPC B60R 25/24; G06F 21/44; B60R 25/2072; H04W 12/06; H04W 12/009

(57) ABSTRACT

An on-vehicle device includes a determination unit, an instruction unit, and a modification unit. The determination unit determines whether to unlock doors based on a rolling code from a portable device and a reference rolling code to be collated with the rolling code. When the determination unit determines to unlock the doors, the instruction unit instructs the portable device to increase a value of the rolling code. When the portable device accepts the instruction from the instruction unit, the modification unit increases a value of the reference rolling code to be used in the determination unit.

### TECHNICAL FIELD

The present disclosure relates to a communication technology, and particularly relates to a portable device, an on-vehicle device mounted to a vehicle, and a vehicle wireless communication system that are used for performing communication between the on-vehicle device and the portable device carried by a user.

### BACKGROUND ART

In a wireless door rock control system for vehicles, a portable device transmits a radio signal including a specific identification (ID) code (authentication code), and an on-vehicle device unlocks a door when the ID code included in the received radio signal coincides with an ID code preset in the on-vehicle device. This reduces the possibility of unlocking the door by another person. The radio signal also includes, in addition to the ID code, a rolling code that is progressively modified in accordance with a number of transmissions. The on-vehicle device also uses the rolling code to determine whether the door is to be unlocked. Therefore, even when the radio signal is copied by a device that intercepts the radio signal, since the rolling code is modified every transmission and is used for the determination, the door cannot be unlocked only by transmitting the radio signal thus copied (for example, refer to PTL 1).

### CITATION LIST

### Patent Literature

PTL 1: Japanese Patent Unexamined Publication No. H8-102982

### SUMMARY OF THE INVENTION

A roll-jam attack is one of methods in which another person illegally unlocks a door while such a rolling code is used.

The present disclosure provides a technique that reduces a risk of the roll-jam attack for unlocking the door.

An on-vehicle device according to a first aspect of the present disclosure includes a determination unit, an instruction unit, and a modification unit. The determination unit determines whether to unlock a door based on a rolling code from a portable device and a reference rolling code to be collated with the rolling code. When the determination unit determines to unlock the door, the instruction unit instructs the portable device to increase a value of the rolling code. When the portable device accepts the instruction from the instruction unit, the modification unit increases a value of the reference rolling code to be used in the determination unit.

A portable device according to the first aspect of the present disclosure includes a request unit, a reception unit, and a response unit. The request unit requests an on-vehicle device to unlock a door by transmitting a signal including a rolling code. When the on-vehicle device determines to unlock the door based on the rolling code and a reference rolling code to be collated with the rolling code according to the request from the request unit, the reception unit receives an instruction for increasing a value of the rolling code from the on-vehicle device. Based on the instruction received in reception unit, the response unit increases the value of the rolling code, and notifies the on-vehicle device of the acceptance of the instruction. When the response unit notifies of the acceptance of the instruction, the on-vehicle device increases a value of the reference rolling code.

A vehicle wireless communication system according to the first aspect of the present disclosure includes a portable device and an on-vehicle device. The portable device requests to unlock a door by transmitting a signal including a rolling code. The on-vehicle device determines whether to unlock the door based on the rolling code from the portable device and a reference rolling code to be collated with the rolling code. When determining to unlock the door, the on-vehicle device instructs the portable device to increase a value of the rolling code.

The portable device increases the value of the rolling code based on the received instruction, and notifies the on-vehicle device of acceptance of the instruction. When the portable device accepts the instruction, the on-vehicle device increases a value of the reference rolling code.

A portable device according to a second aspect of the present disclosure includes a request unit, a reception unit, a modification unit, and an instruction unit. The request unit requests an on-vehicle device to unlock a door by transmitting a signal including a rolling code. When the on-vehicle device determines to unlock the door based on the rolling code and a reference rolling code to be collated with the rolling code according to the request from the request unit, the reception unit receives notification from the on-vehicle device. When the reception unit receives the notification, the modification unit increases a value of the rolling code to be used in the request unit. When the reception unit receives the notification, the instruction unit instructs the on-vehicle device to increase a value of the reference rolling code. According to the instruction from the instruction unit, the on-vehicle device increases the value of the reference rolling code.

An on-vehicle device according to the second aspect of the present disclosure includes a determination unit, a notification unit, reception unit, and a modification unit. The determination unit determines whether to unlock a door based on a rolling code from a portable device and a reference rolling code to be collated with the rolling code. When the determination unit determines to unlock the door, the notification unit outputs notification to the portable device. The reception unit receives, from the portable device, an instruction according to the notification from the notification unit, and for increasing the reference rolling code. The modification unit increases a value of the reference rolling code used in the determination unit based on the instruction received in the reception unit. According to the notification from the notification unit, the portable device increases a value of the rolling code.

A vehicle wireless communication system according to the second aspect of the present disclosure includes a portable device and an on-vehicle device. The portable device requests to unlock a door by transmitting a signal including a rolling code. The on-vehicle device determines whether to unlock the door based on the rolling code from the portable device and a reference rolling code to be collated with the rolling code. When determining to unlock the door, the on-vehicle device outputs notification to the portable device. The portable device increases a value of the rolling code based on the received notification, and instructs the on-vehicle device to increase a value of the reference rolling code. Based on the received instruction, the on-vehicle device increases the value of the reference rolling code.

An on-vehicle device according to a third aspect of the present disclosure includes a determination unit, a transmitter, and a receiver. The determination unit determines whether to unlock a door based on a rolling code from a portable device and a reference rolling code to be collated with the rolling code. When the determination unit determines to unlock the door, the transmitter transmits a search signal to the portable device. The receiver receives a response signal from the portable device as a response to the search signal transmitted from the transmitter. When the receiver has not received the response signal, if an operation for opening the door is detected, the determination unit determines to relock the door.

A vehicle wireless communication system according to the third aspect of the present disclosure includes a portable device and an on-vehicle device. The portable device requests to unlock a door by transmitting a signal including a rolling code. The on-vehicle device determines whether to unlock the door based on the rolling code from the portable device and a reference rolling code to be collated with the rolling code. When determining to unlock the door, the on-vehicle device transmits a search signal to the portable device. The portable device transmits a response signal to the on-vehicle device as a response to the search signal. When the response signal has not been received, if an operation for opening the door is detected, the on-vehicle device determines to relock the door.

Any combinations of the above-described components and modifications of the features of the present disclosure in methods, devices, systems, recording media, and computer programs are still effective as other aspects of the present disclosure.

According to the present disclosure, it is possible to reduce a risk of a roll-jam attack for unlocking a door.

### BRIEF DESCRIPTION OF DRAWINGS

FIG. 1A illustrates an outline of an unlocking operation in smart communication performed by a vehicle wireless communication system.

FIG. 1B illustrates a format of a search signal in the smart communication performed by the vehicle wireless communication system.

FIG. 1C illustrates a format of a response signal in the smart communication performed by the vehicle wireless communication system.

FIG. 2A illustrates an outline of keyless communication performed by the vehicle wireless communication system.

FIG. 2B illustrates a format of a keyless signal in the keyless communication performed by the vehicle wireless communication system.

FIG. 3A illustrates normal processing of the keyless communication illustrated in FIG. 2A.

FIG. 3B illustrates the normal processing of the keyless communication.

FIG. 3C illustrates the normal processing of the keyless communication at a timing next to the case of FIG. 3B.

FIG. 3D illustrates the normal processing of the keyless communication at a timing later than FIG. 3C.

FIG. 4A illustrates roll-jam attack processing on the keyless communication illustrated in FIG. 2A.

FIG. 4B illustrates the roll-jam attack processing at a timing next to the case of FIG. 4A.

FIG. 4C illustrates the roll-jam attack processing at a timing next to the case of FIG. 4B.

FIG. 5 is a view illustrating a configuration of a vehicle wireless communication system according to a first exemplary embodiment of the present disclosure.

FIG. 6 is a sequence diagram illustrating a processing procedure performed by the vehicle wireless communication system illustrated in FIG. 5.

FIG. 7 is a flowchart illustrating a processing procedure performed by an on-vehicle device in the vehicle wireless communication system illustrated in FIG. 5.

FIG. 8 is a flowchart illustrating a processing procedure performed by a portable device in the vehicle wireless communication system illustrated in FIG. 5.

FIG. 9 is a view illustrating a configuration of a vehicle wireless communication system according to a second exemplary embodiment of the present disclosure.

FIG. 10 is a sequence diagram illustrating a processing procedure performed by the vehicle wireless communication system illustrated in FIG. 9.

FIG. 11 is a flowchart illustrating a processing procedure performed by a portable device in the vehicle wireless communication system illustrated in FIG. 9.

FIG. 12 is a flowchart illustrating a processing procedure performed by an on-vehicle device in the vehicle wireless communication system illustrated in FIG. 9.

FIG. 13 is a view illustrating a configuration of a vehicle wireless communication system according to a third exemplary embodiment of the present disclosure.

FIG. 14 is a sequence diagram illustrating a processing procedure performed by the vehicle wireless communication system illustrated in FIG. 13.

FIG. 15 is a flowchart illustrating a processing procedure performed by an on-vehicle device in the vehicle wireless communication system illustrated in FIG. 13.

FIG. 16 is a flowchart illustrating another processing procedure performed by the on-vehicle device in the vehicle wireless communication system illustrated in FIG. 13.

### DESCRIPTION OF EMBODIMENTS

Prior to specifically describing various exemplary embodiments of the present disclosure, outlines of a typical vehicle wireless communication system and a roll-jam attack will be described. The vehicle wireless communication system includes an on-vehicle device mounted to a vehicle and a portable device (electronic key) carried by a user, and performs wireless communication for unlocking doors of the vehicle between the on-vehicle device and the portable device. In the vehicle wireless communication system, when the user tries to unlock the doors of the vehicle using the portable device, the portable device transmits a signal including a rolling code to unlock the doors.

With the signal including the rolling code being transmitted, another person performs the roll-jam attack to illegally unlock the doors in some cases. A device for performing the roll-jam attack (hereinafter, referred to as an “unauthorized device”) receives the signal including the rolling code from the portable device, and transmits jamming radio waves to the on-vehicle device. The unauthorized device copies the signal including the rolling code from the portable device. The on-vehicle device does not receive the signal including the rolling code from the portable device, and only receives the jamming radio waves, so that the doors are not unlocked. The user therefore retries to unlock the doors of the vehicle using the portable device. This causes the portable device to transmit a signal including a second rolling code. A value of the second rolling code is set larger than a value of the first rolling code. For example, the value of the second rolling code is incremented by “1” from the value of the first rolling code.

Upon receiving the signal including the second rolling code from the portable device, similar to the first reception, the unauthorized device transmits the jamming radio waves to the on-vehicle device. The unauthorized device transmits a signal including the first rolling code that has already been copied to the on-vehicle device, and copies the signal including the second rolling code. The on-vehicle device does not receive the signal including the second rolling code due to the jamming radio waves, but receives the signal including the first rolling code, so that the doors are unlocked. As a result, the user of the portable device unlocks the doors legally to board the vehicle. Meanwhile, after the user of the portable device uses the vehicle, the unauthorized device transmits the signal including the second rolling code thus copied to the on-vehicle device of the vehicle whose doors are locked. The on-vehicle device receives the signal including the second rolling code, and unlocks the doors. As a result, the other person who uses the unauthorized device illegally unlocks the doors to board the vehicle.

In a vehicle wireless communication system according to various exemplary embodiments of the present disclosure, as described above, wireless communication is performed between an on-vehicle device and a portable device. For door unlocking in the wireless communication, two kinds of communication sequences are defined. Those are also used in the typical vehicle wireless communication system. A first kind of the communication sequences uses a rolling code and performs one-way communication from the portable device to the on-vehicle device. This communication sequence is referred to as “keyless communication”. A second kind of the communication sequences performs two-way communication between the on-vehicle device and the portable device. This communication sequence is referred to as “smart communication”. The smart communication is also referred to as a smart entry system, a smart key system, or a passive keyless entry (PKE) system.

Next, outlines of the smart communication and the keyless communication and an outline of a roll-jam attack on the keyless communication will be described.

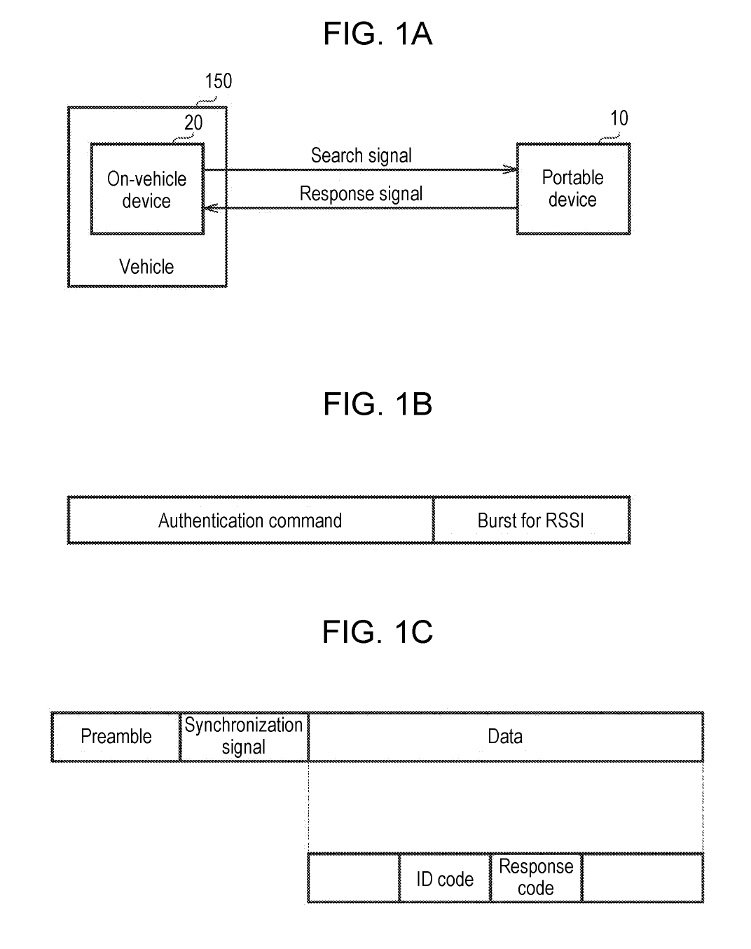

FIGS. 1A to 1C illustrate an outline of the smart communication performed by the typical vehicle wireless communication system. FIG. 1A illustrates an unlocking operation performed by the vehicle wireless communication system. The vehicle wireless communication system includes portable device 10 and on-vehicle device 20. On-vehicle device 20 is mounted on vehicle 150. When doors of vehicle 150 are locked, a user carrying portable device 10, that is, a user who is going to board vehicle 150 touches a door knob of vehicle 150. With the door knob of vehicle 150 being touched as a trigger, on-vehicle device 20 transmits a search signal to portable device 10. The search signal is a signal of a low frequency (LF), for example, a signal of a 125 kHz band. A communication distance of the signal of the LF is limited to a range of approximately 2 m from vehicle 150.

FIG. 1B illustrates a format of the search signal. In the search signal, an authentication command and a burst for a received signal strength indicator (RSSI) are disposed in this order. The authentication command includes an ID code for discriminating portable device 10, a functional command for identifying a function to be performed through the smart communication, for example, unlocking the doors, and the like. Further, the authentication command is encrypted. The burst for the RSSI is a signal for causing portable device 10 to measure reception signal strength. The burst for the RSSI may be used as in the past, and therefore description thereof is omitted.

In FIG. 1A, upon receiving the search signal, portable device 10 decrypts details of the authentication command illustrated in FIG. 1B. When portable device 10 recognizes that the search signal is transmitted from authorized on-vehicle device 20 based on the ID code included in the authentication command, portable device 10 transmits a response signal to on-vehicle device 20. The response signal is a signal of an ultra high frequency (UHF), for example, a signal of a 300 MHz band. Note that the signal of the UHF is also referred to as a signal of a radio frequency (RF).

FIG. 1C illustrates a format of the response signal. In the response signal, a preamble, a synchronization signal, and data are disposed in this order. The preamble and the synchronization signal are known signals used for establishing communication between portable device 10 and on-vehicle device 20. The data includes an ID code and a response code. The ID code is a code for identify portable device 10 as described above, and the response code is information for indicating that the response signal is a signal corresponding to the authentication command. Any publicly known technique is applicable to those codes, and therefore, description of those codes will be omitted herein.

In FIG. 1A, on-vehicle device 20 receives the response signal. On-vehicle device 20 determines whether a response to the search signal that has already been transmitted is received from portable device 10, based on the ID code and the response code included in the response signal. Upon determining that the response is received, on-vehicle device 20 unlocks the doors of vehicle 150.

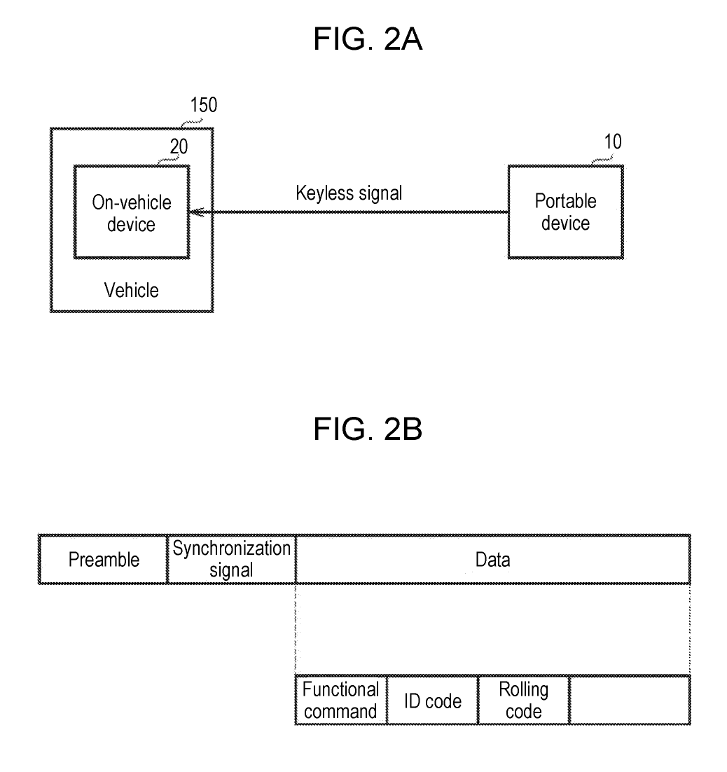

FIGS. 2A and 2B illustrate an outline of the keyless communication performed by the typical vehicle wireless communication system. When the user conducts the operation for unlocking the doors, portable device 10 transmits a keyless signal to on-vehicle device 20, as illustrated in FIG. 2A. The operation for unlocking the doors conducted by the user is, for example, to depress a button (not illustrated) provided in portable device 10. Further, the keyless signal is a signal of a frequency band identical to that of the response signal.

FIG. 2B illustrates a format of the keyless signal. The keyless signal disposes a preamble, a synchronization signal, and data in this order. The preamble and the synchronization signal are the same as those in the response signal. The data includes a functional command, an ID code, and a rolling code. The functional command indicates information for identifying a function to be performed through the keyless communication, for example, unlocking the doors. The rolling code indicates a value that increases every transmission of the keyless signal from portable device 10, and is represented with two bytes, for example. Specifically, the value of the rolling code increases by “1” every transmission of the keyless signal.

As illustrated in FIG. 2A, on-vehicle device 20 receives the keyless signal. On-vehicle device 20 determines whether to unlock the doors of vehicle 150 or not based on the ID code and the rolling code included in the keyless signal. In particular, when the rolling code satisfies a condition, on-vehicle device 20 unlocks the doors.

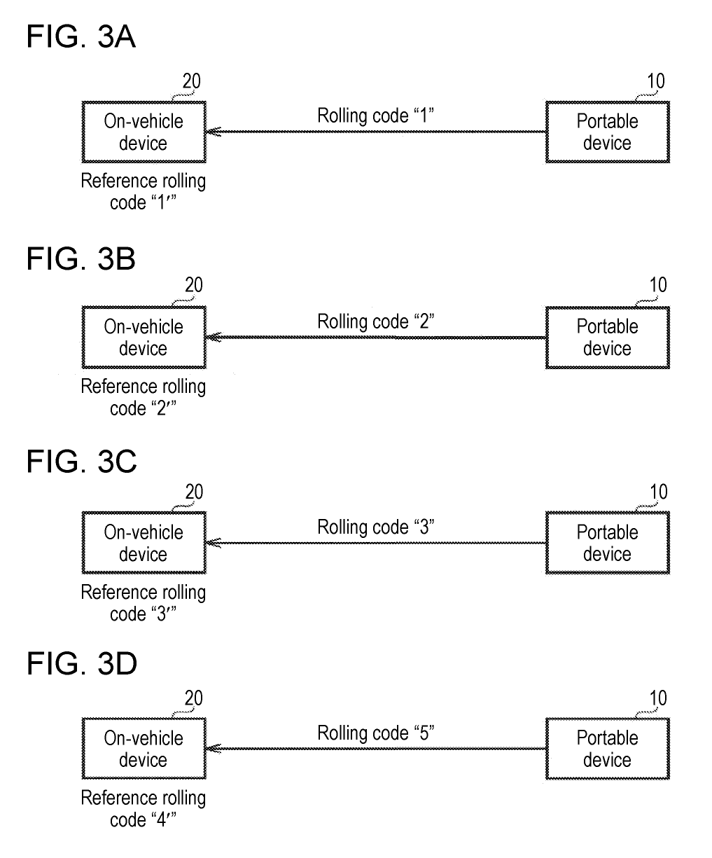

Next, with reference to FIGS. 3A to 3D, the condition for the rolling code will be described. FIGS. 3A to 3D illustrate normal processing of the keyless communication. FIG. 3A illustrates a case where the keyless signal is transmitted from portable device 10 at a predetermined timing. Herein, to clarify the description, it is assumed that the value of the rolling code included in the keyless signal is “1”. On-vehicle device 20 pre-stores a rolling code to be collated with the rolling code included in the keyless signal transmitted from portable device 10 (hereinafter, referred to as a “reference rolling code”). Note that, a value of the reference rolling code is assumed to be “1”, but the value of “1” of the reference rolling code is indicated as “1”, to clarify a difference in notation with the value of the rolling code. On-vehicle device 20 specifies a condition that “a value of the rolling code is greater than or equal to a value of the reference rolling code”, and unlocks the doors when the condition is satisfied. The value of “1” of the rolling code and the value of “1” of the reference rolling code satisfy the condition.

FIG. 3B illustrates a case where the keyless signal is transmitted from portable device 10 at a timing next to the case of FIG. 3A. When the value of “1” of the rolling code has been included in the keyless signal, portable device 10 increments the value of the rolling code to “2”, and when the value of “1” of the reference rolling code has been used, on-vehicle device 20 increments the value of the reference rolling code to “2”. Note that, the value of the rolling code and the value of the reference rolling code are incremented also when the keyless signal is transmitted for locking the doors. However, to clarify the description, the keyless signal herein is assumed to be transmitted only for unlocking the doors. The value of “2” of the rolling code and the value of “2” of the reference rolling code satisfy the above-described condition in on-vehicle device 20.

FIG. 3C illustrates a case where the keyless signal is transmitted from portable device 10 at a timing next to the case of FIG. 3B. Also in this case, the value of “3” of the rolling code and the value of “3” of the reference rolling code satisfy the above-described condition. FIG. 3D illustrates a case where the keyless signal is transmitted from portable device 10 at a timing later than FIG. 3C. Specifically, a case where the button provided in portable device 10 is incorrectly depressed between the timing in FIG. 3C and the timing in FIG. 3D is assumed. Also with the incorrect depression of the button, portable device 10 transmits the keyless signal, but on-vehicle device 20 does not receive the keyless signal. Through such processing, the value of the rolling code is incremented, but the value of the reference rolling code is not incremented. Therefore, as illustrated in FIG. 3D, the value of the rolling code included in the keyless signal to be transmitted next is “5”, but the value of the reference rolling code in on-vehicle device 20 is “4”. Also in this case, the above-described condition is satisfied.

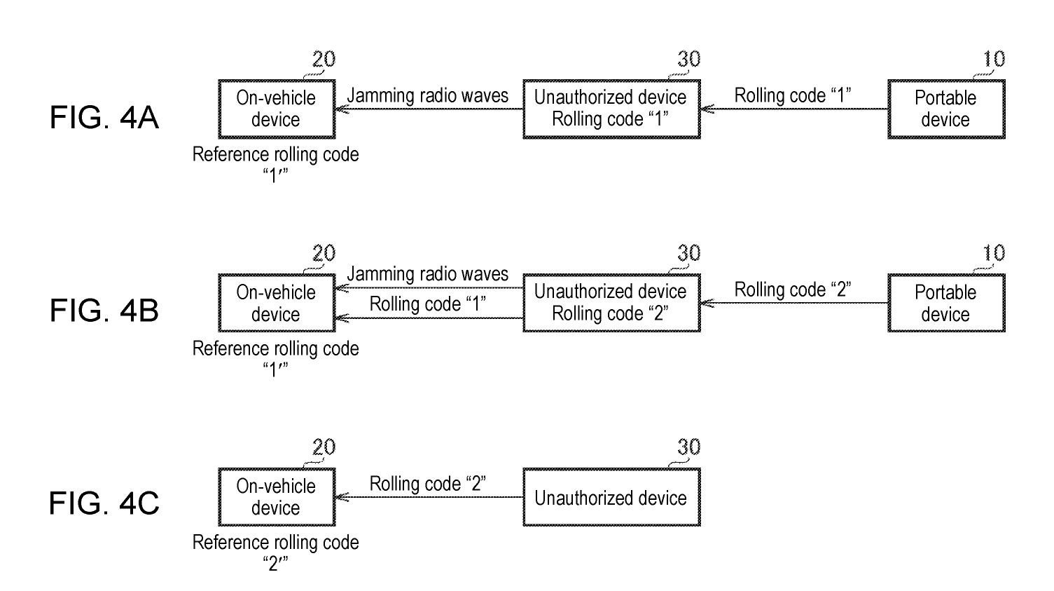

The roll-jam attack performed in such keyless communication will be described with reference to FIGS. 4A to 4C. FIGS. 4A to 4C illustrate roll-jam attack processing on the keyless communication. Unauthorized device 30 used by another person is disposed between portable device 10 and on-vehicle device 20.

In FIG. 4A, similar to FIG. 3A, the keyless signal including the value of “1” of the rolling code is transmitted from portable device 10. Upon receiving the keyless signal from portable device 10, unauthorized device 30 transmits jamming radio waves to on-vehicle device 20, and stores the keyless signal. This operation storing the keyless signal corresponds to the copy described above. Therefore, on-vehicle device 20 receives only the jamming radio waves, and does not receive the keyless signal, so that the doors are not unlocked.

FIG. 4B illustrates a situation at a timing next to the case of FIG. 4A. Even though the user depresses the button of portable device 10 in FIG. 4A, the doors are not unlocked. The user then depresses the button again to unlock the doors. With this operation, portable device 10 transmits the keyless signal including the value of “2” of the rolling code.

Upon receiving the keyless signal from portable device 10, unauthorized device 30 transmits the jamming radio waves to on-vehicle device 20, and stores the keyless signal. Meanwhile, unauthorized device 30 transmits, to on-vehicle device 20, the keyless signal including the value of “1” of the rolling code that has already been stored, following the transmission of the jamming radio waves to on-vehicle device 20. On-vehicle device 20 does not receive the keyless signal including the value of “2” of the rolling code due to the jamming radio waves, and receives the keyless signal including the value of “1” of the rolling code transmitted following the jamming radio waves. The value of “1” of the rolling code and the value of “1” of the reference rolling code satisfy the above-described condition. The doors are therefore unlocked, and the user of portable device 10 boards vehicle 150 (refer to FIG. 2A). At this time, the value of the reference rolling code in on-vehicle device 20 is updated to “2”.

FIG. 4C illustrates a situation at a timing next to the case of FIG. 4B, and a situation in which the user has finished using vehicle 150 (refer to FIG. 2A) and the doors are locked is assumed. Unauthorized device 30 transmits, to on-vehicle device 20, the keyless signal including the value of “2” of the rolling code, which has been stored. On-vehicle device 20 receives the keyless signal. The value of “2” of the rolling code and the value of “2” of the reference rolling code satisfy the above-described condition, thereby unlocking the doors. The other person using unauthorized device 30 therefore boards vehicle 150 (refer to FIG. 2A).

Hereinafter, various exemplary embodiments relating to a configuration for preventing the roll-jam attack will be described. Note that, in each exemplary embodiment, components identical to components of a preceding exemplary embodiment are denoted by the same numerals or symbols, and detailed description thereof is omitted. Note that the configurations of the signals illustrated in FIG. 1B, FIG. 1C, and FIG. 2B are the same also in the following exemplary embodiments.

### First Exemplary Embodiment

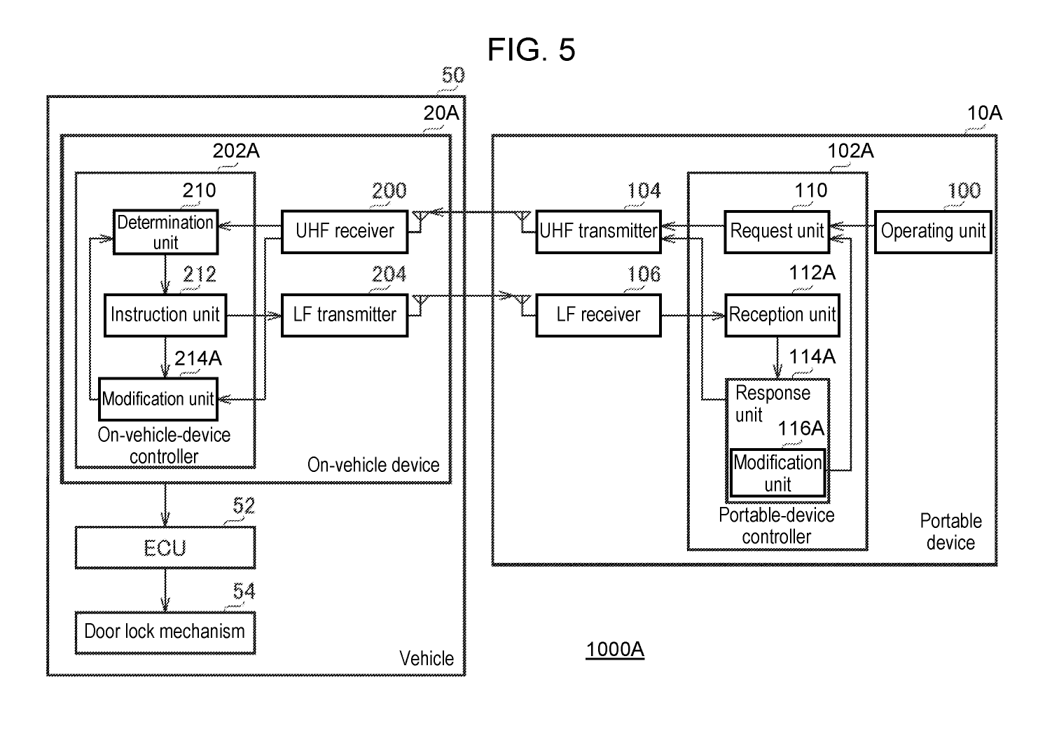

FIG. 5 illustrates a configuration of vehicle wireless communication system (hereinafter, system) 1000A according to a first exemplary embodiment of the present disclosure. System 1000A includes portable device 10A and on-vehicle device 20A.

In the present exemplary embodiment, to reduce a risk of the roll-jam attack, upon receiving a signal including a first rolling code and unlocking the doors, on-vehicle device 20A performs two-way communication with portable device 10A. With this wireless communication, on-vehicle device 20A causes portable device 10A to modify a value of a rolling code to be a value that is not unlocked with a value of a second rolling code. On-vehicle device 20A determines to unlock the doors based on the modified value of the rolling code, whereby on-vehicle device 20A does not unlock the doors even when receiving a signal including the second rolling code from an unauthorized device. Note that, although detailed description is omitted, on-vehicle device 20A may automatically open the unlocked doors subsequent to unlocking the doors.

Portable device 10A includes operating unit 100, portable-device controller (hereinafter, controller) 102A, UHF transmitter 104, and LF receiver 106. Controller 102A includes request unit 110, reception unit 112A, and response unit 114A. Response unit 114A includes modification unit 116A.

On-vehicle device 20A is mounted on vehicle 50. On-vehicle device 20A includes UHF receiver 200, on-vehicle-device controller (hereinafter, controller) 202A, and LF transmitter 204. Controller 202A includes determination unit 210, instruction unit 212, and modification unit 214A. Vehicle 50 includes electronic control unit (ECU) 52 and door lock mechanism 54.

Operating unit 100 of portable device 10A corresponds to the button described above, and is depressed when the user requests for unlocking the doors of vehicle 50. When operating unit 100 is operated, operating unit 100 sends notification to request unit 110. Upon receiving the notification from operating unit 100, request unit 110 generates the keyless signal including an ID code and the rolling code. The format of the keyless signal is as described above. Request unit 110 outputs the keyless signal to UHF transmitter 104. Upon receiving the keyless signal from request unit 110, UHF transmitter 104 transmits the keyless signal to the outside, that is, on-vehicle device 20A. In this manner, request unit 110 and UHF transmitter 104 request on-vehicle device 20A to unlock the doors with the keyless signal including the rolling code. Request unit 110 then increments the value of the rolling code by “1”, and retains the value of the rolling code thus incremented.

UHF receiver 200 of on-vehicle device 20A receives, from the outside, the keyless signal transmitted from portable device 10A. UHF receiver 200 outputs the keyless signal to determination unit 210. Upon receiving the keyless signal from UHF receiver 200, determination unit 210 extracts the ID code and the rolling code from the keyless signal. Determination unit 210 executes pair authentication based on the extracted ID code and an ID code retained in advance. Any publicly known technique only needs to be applied to the pair authentication, and therefore, description of the pair authentication will be omitted herein. When the pair authentication succeeds, determination unit 210 determines whether a predetermined condition is satisfied or not based on the rolling code and the reference rolling code.

The predetermined condition is defined such that “the value of the rolling code is greater than or equal to the value of the reference rolling code”, for example. When the condition is satisfied, determination unit 210 determines to unlock the doors. In contrast, when the condition is not satisfied, determination unit 210 refuses to unlock the doors. An additional condition that “a difference between the value of the rolling code and the value of the reference rolling code is within a certain range, inclusive” may be defined. Based on such an additional condition, when “the value of the rolling code is greater than or equal to the value of the reference rolling code, and the difference between them is less than or equal to 100”, for example, determination unit 210 determines to unlock the doors.

Upon determining to unlock the doors, determination unit 210 instructs ECU 52 of vehicle 50 to unlock door lock mechanism 54. Any publicly known technique can be applied to ECU 52 and door lock mechanism 54, and therefore description of those components will be omitted herein. Note that in the case where unlocking the doors is determined, or in the case where door lock mechanism 54 is unlocked, determination unit 210 increments the value of the reference rolling code by “1”, and retains the value of the reference rolling code.

When determination unit 210 determines to unlock the door, instruction unit 212 instructs portable device 10A to increase the value of the rolling code. Similar to the case of FIG. 4C, at this stage, the value of the reference rolling code retained in determination unit 210 coincides with the value of the rolling code stored in unauthorized device 30. In order not to satisfy the above-described condition, the value of the reference rolling code should be increased to be greater than the value of the rolling code stored in unauthorized device 30. On the other hand, when only the value of the reference rolling code is increased, the value of the rolling code retained in portable device 10A does not also satisfy the above-described condition. To avoid such a situation, portable device 10A is caused to increase the value of the rolling code so as to match the value of the reference rolling code thus increased.

Instruction unit 212 uses a search signal in smart communication to instruct portable device 10A to increase the value of the rolling code. Specifically, an authentication command in the search signal includes a value to be increased of the rolling code. In other words, instruction unit 212 instructs portable device 10A to have an increased value of the rolling code. Alternatively, the authentication command in the search signal may include an amount to be increased of the value of the rolling code. The former case corresponds to designation with an absolute value, and the latter case corresponds to designation with a relative value. Note that, in the former case, a value having no relation with a current value of the rolling code and the value of the reference rolling code may be designated. In the latter case, an amount of information for the instruction is smaller than an amount of information for the rolling code. On the other hand, when the above-described additional condition is defined, instruction unit 212 may instruct to decrease the value of the rolling code such that the value of the rolling code becomes small while exceeding the certain range. Instruction unit 212 outputs the generated search signal to LF transmitter 204. Further, instruction unit 212 notifies modification unit 214A of the value of the rolling code thus instructed. LF transmitter 204 transmits the search signal to portable device 10A.

LF receiver 106 of portable device 10A receives the search signal transmitted from on-vehicle device 20A. LF receiver 106 outputs the search signal to reception unit 112A. Reception unit 112A extracts the ID code included in the search signal. Reception unit 112A further performs the pair authentication based on the ID code retained in advance and the extracted ID. When the pair authentication fails, a process described below is not executed. In contrast, when the pair authentication succeeds, reception unit 112A extracts the instruction for increasing the value of the rolling code from the search signal. Reception unit 112A outputs the instruction for increasing the value of the rolling code to response unit 114A.

Modification unit 116A in response unit 114A modifies the value of the rolling code in request unit 110 based on the instruction for increasing the value of the rolling code. In other words, modification unit 116A increases the value of the rolling code. Note that, when to decrease the value of the rolling code is instructed, modification unit 116A may decrease the value of the rolling code in request unit 110. Response unit 114A notifies on-vehicle device 20A of acceptance of the instruction based on the instruction received by reception unit 112A. A response signal in the smart communication is used for this purpose. Specifically, a value indicating the acceptance is set in the data in the response signal.

Response unit 114A outputs the response signal to UHF transmitter 104. UHF transmitter 104 transmits the response signal to on-vehicle device 20A.

UHF receiver 200 of on-vehicle device 20A receives the response signal from portable device 10A. UHF receiver 200 outputs the response signal to modification unit 214A. When modification unit 214A receives the response signal from portable device 10A, that is, when portable device 10A accepts the instruction from instruction unit 212, modification unit 214A sets the value of the rolling code received from instruction unit 212 to determination unit 210 as the value of the reference rolling code. Based on this operation, the value of the reference rolling code to be used in determination unit 210 is increased.

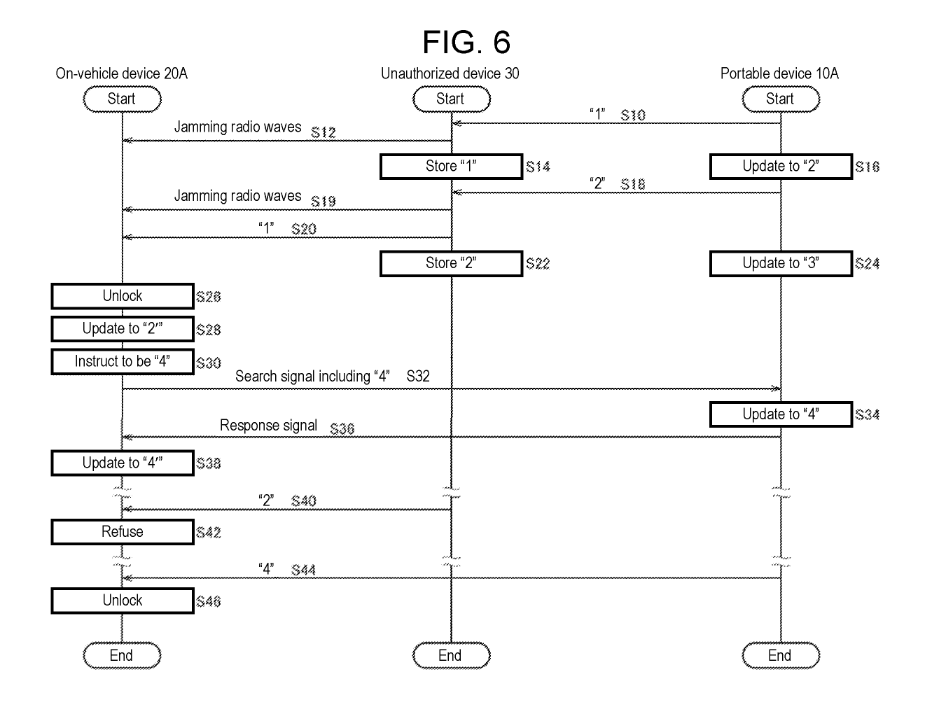

An operation of system 1000A thus configured will be described. FIG. 6 is a sequence diagram illustrating a processing procedure performed by system 1000A. Portable device 10A transmits the keyless signal including the value of “1” of the rolling code (S10). Upon receiving the keyless signal, unauthorized device 30 transmits the jamming radio waves (S12), and stores the keyless signal including the value of “1” of the rolling code (S14). Portable device 10A updates the value of the rolling code to “2” (S16), and transmits the keyless signal including the value of “2” of the rolling code (S18). Upon receiving the keyless signal, unauthorized device 30 transmits the jamming radio waves (S19), and transmits the keyless signal including the value of “1” of the rolling code (S20). Unauthorized device 30 then stores the keyless signal including the value of “2” of the rolling code (S22). Portable device 10A updates the value of the rolling code to “3” (S24).

Since the value of “1” of the rolling code included in the keyless signal coincides with “1” of the reference rolling code thus retained, on-vehicle device 20A determines unlocking (S26). On-vehicle device 20A updates the value of the reference rolling code to “2” (S28). On-vehicle device 20A generates the search signal to instruct for increasing the value of the rolling code to be “4” (S30). Herein, the value of the rolling code is increased by “2”, but an increasing amount may be “1”, or may be “3” or more. On-vehicle device 20A transmits the search signal including the value of “4” of the rolling code to portable device 10A (S32). Portable device 10A updates the value of the rolling code to “4” (S34). Portable device 10A transmits the response signal for indicating the acceptance of the instruction to on-vehicle device 20A (S36). On-vehicle device 20A updates the value of the reference rolling code to “4” (S38).

Unauthorized device 30 transmits the keyless signal including the value of “2” of the rolling code (S40). Since the value of “2” of the rolling code included in the keyless signal is smaller than “4” of the retained reference rolling code, on-vehicle device 20A refuses unlocking (S42). Portable device 10A transmits the keyless signal including the value of “4” of the rolling code (S44). Since the value of “4” of the rolling code included in the keyless signal coincides with “4” of the retained reference rolling code, on-vehicle device 20A determines unlocking (S46).

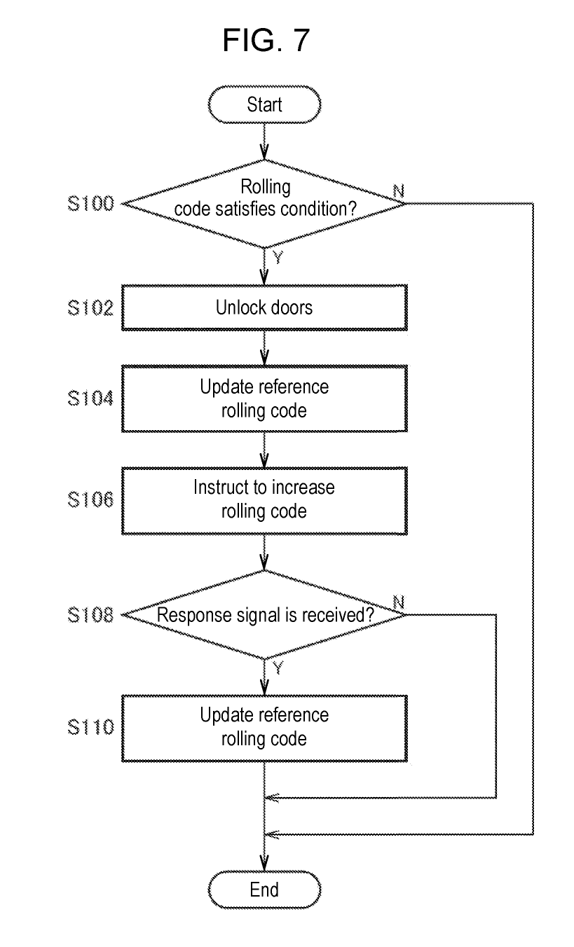

FIG. 7 is a flowchart illustrating a processing procedure performed by on-vehicle device 20A. When the rolling code satisfies the condition (Y in S100), determination unit 210 determines to unlock the doors (S102). Further, determination unit 210 updates the value of the reference rolling code (S104). Instruction unit 212 instructs portable device 10A to increase the value of the rolling code (S106). Upon receiving the response signal from portable device 10A (Y in S108), modification unit 214A updates the value of the reference rolling code (S110). When the rolling code does not satisfy the condition (N in S100), or when the response signal is not received from portable device 10A (N in S108), the process is terminated.

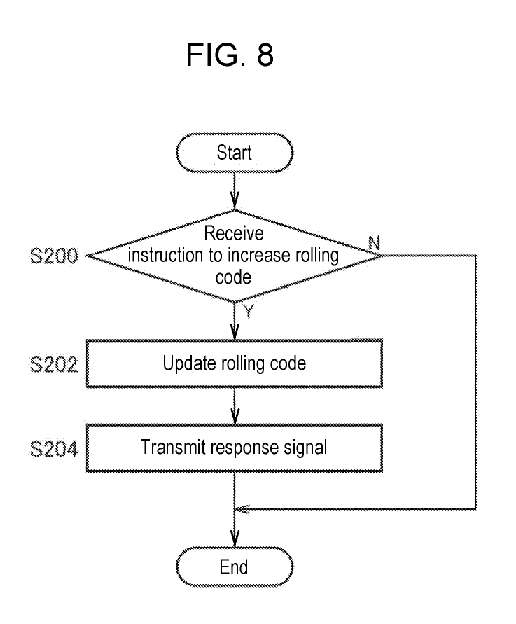

FIG. 8 is a flowchart illustrating a processing procedure performed by portable device 10A. When reception unit 112A receives the instruction for increasing the value of the rolling code from on-vehicle device 20A (Y in S200), modification unit 116A updates the value of the rolling code (S202). Response unit 114A transmits the response signal to on-vehicle device 20A (S204). When reception unit 112A does not receive the instruction for increasing the value of the rolling code from on-vehicle device 20A (N in S200), the process is terminated.

According to the present exemplary embodiment, when determining the door unlocking based on the keyless signal including the rolling code from portable device 10A, on-vehicle device 20A instructs portable device 10A to increase the value of the rolling code. Therefore, the rolling code having a value different from the value of the rolling code stored in unauthorized device 30 is set in portable device 10A. On-vehicle device 20A increases the value of the reference rolling code. Therefore, even when receiving the value of the rolling code stored in unauthorized device 30, on-vehicle device 20A can prevent door unlocking On the other hand, since on-vehicle device 20A increases the value of the reference rolling code, on-vehicle device 20A can unlock the doors by the keyless signal including the rolling code from portable device 10A. These processes can decrease a risk of the roll-jam attack.

On-vehicle device 20A notifies of the value to be increased of the rolling code. Therefore, the value of the rolling code and the value of the reference rolling code can surely coincide with each other. Alternatively, on-vehicle device 20A notifies of the amount to be increased. Therefore, an amount of information to be notified can be suppressed from increasing. According to the instruction from on-vehicle device 20A, portable device 10A increases the value of the rolling code, and the value of the reference rolling code in on-vehicle device 20A is increased, whereby the risk of the roll-jam attack can be decreased.

As described above, on-vehicle device 20A includes determination unit 210, instruction unit 212, and modification unit 214A. Determination unit 210 determines whether to unlock the doors or not based on the rolling code from portable device 10A and the reference rolling code to be collated with the rolling code. When determination unit 210 determines to unlock the door, instruction unit 212 instructs portable device 10A to increase the value of the rolling code. When portable device 10A accepts the instruction from instruction unit 212, modification unit 214A increases the value of the reference rolling code being used in determination unit 210.

With this configuration, when determining to unlock the door based on the keyless signal including the rolling code from portable device 10A, on-vehicle device 20A instructs portable device 10A to increase the value of the rolling code. Further, on-vehicle device 20A increases the value of the reference rolling code. Therefore, the risk of the roll-jam attack can be decreased.

Instruction unit 212 may notify portable device 10A of the value to be increased of the rolling code. In this case, the value of the rolling code and the value of the reference rolling code can surely coincide with each other.

Instruction unit 212 may notify portable device 10A of the amount to be increased of the value of the rolling code. In this case, the amount to be increased is notified. Therefore, an amount of information to be notified is suppressed from increasing.

Portable device 10A includes request unit 110, reception unit 112A, and response unit 114A. Request unit 110 requests on-vehicle device 20A to unlock the doors by transmitting the signal including the rolling code. When on-vehicle device 20A determines to unlock the doors based on the rolling code and the reference rolling code to be collated with the rolling code according to the request from request unit 110, reception unit 112A receives the instruction for increasing the value of the rolling code from on-vehicle device 20A. Based on the instruction received in reception unit 112A, response unit 114A increases the value of the rolling code, and notifies on-vehicle device 20A of the acceptance of the instruction. When response unit 114A notifies of the acceptance of the instruction, on-vehicle device 20A increases the value of the reference rolling code.

With this configuration, portable device 10A increases the value of the rolling code according to the instruction, and the value of the reference rolling code in on-vehicle device 20A is increased, whereby the risk of the roll-jam attack can be decreased.

System 1000A includes portable device 10A and on-vehicle device 20A. Portable device 10A requests to unlock the doors by transmitting the signal including the rolling code. On-vehicle device 20A determines whether to unlock the doors based on the rolling code from portable device 10A and the reference rolling code to be collated with the rolling code. When determining to unlock the doors, on-vehicle device 20A instructs portable device 10A to increase the value of the rolling code. Portable device 10A increases the value of the rolling code based on the received instruction, and notifies on-vehicle device 20A of the acceptance of the instruction. When portable device 10A accepts the instruction, on-vehicle device 20A increases the value of the reference rolling code.

With this configuration, when determining to unlock the doors based on the keyless signal including the rolling code from portable device 10A, on-vehicle device 20A instructs portable device 10A to increase the value of the rolling code. Further, on-vehicle device 20A increases the value of the reference rolling code. Therefore, the risk of the roll-jam attack can be decreased.

### Second Exemplary Embodiment

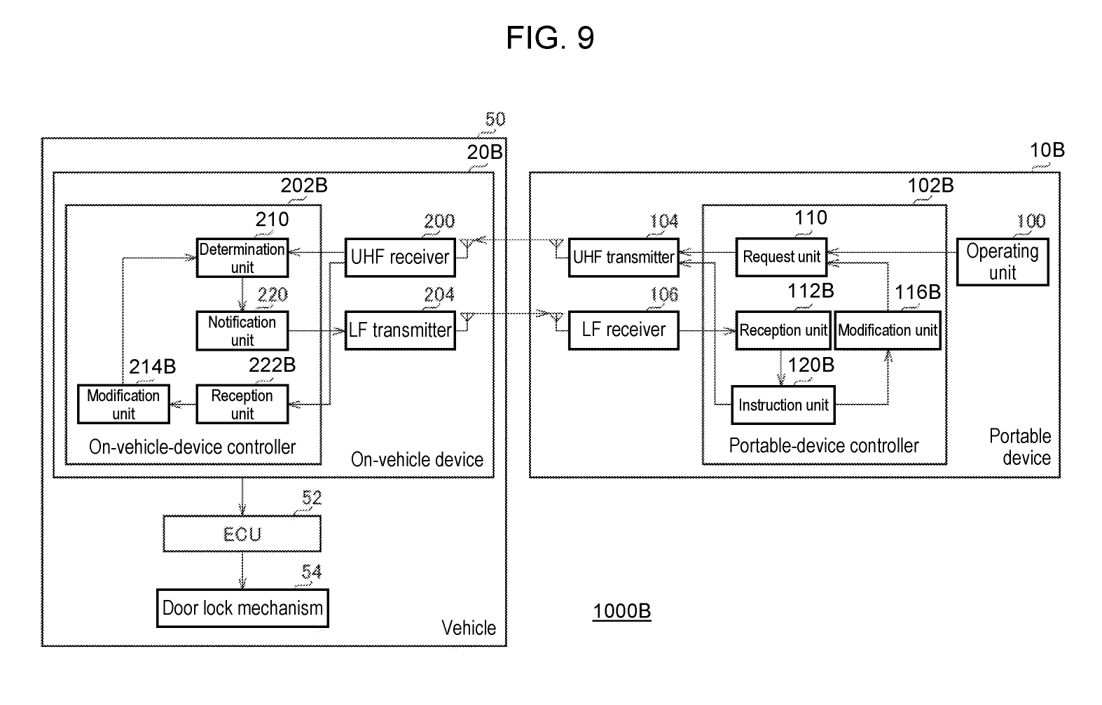

FIG. 9 illustrates a configuration of vehicle wireless communication system (hereinafter, system) 1000B according to a second exemplary embodiment of the present disclosure. System 1000B includes portable device 10B and on-vehicle device 20B.

In the present exemplary embodiment, to decrease a risk of a roll-jam attack, when on-vehicle device 20B unlocks doors by receiving a signal including a first rolling code, on-vehicle device 20B performs two-way wireless communication with portable device 10B. With this wireless communication, portable device 10B causes on-vehicle device 20B to modify a value of a reference rolling code to be a value that is not unlocked with a value of a second rolling code. On-vehicle device 20B determines to unlock the doors based on the modified value of the reference rolling code. Therefore, on-vehicle device 20B does not unlock the doors even when receiving a signal including the second rolling code from an unauthorized device. Note that, although detailed description is omitted, on-vehicle device 20B may automatically open the unlocked doors subsequent to unlocking the doors.

Portable device 10B includes operating unit 100, portable-device controller (hereinafter, controller) 102B, UHF transmitter 104, and LF receiver 106. Controller 102B includes request unit 110, reception unit 112B, modification unit 116B, and instruction unit 120B.

On-vehicle device 20B is mounted on vehicle 50. On-vehicle device 20B includes UHF receiver 200, on-vehicle-device controller (hereinafter, controller) 202B, and LF transmitter 204. Controller 202B includes determination unit 210, modification unit 214B, notification unit 220, and reception unit 222B. Similar to the first exemplary embodiment, vehicle 50 includes ECU 52 and door lock mechanism 54.

Operating unit 100, request unit 110, and UHF transmitter 104 in portable device 10B are similar to those in the first exemplary embodiment. In other words, when operating unit 100 is operated, operating unit 100 sends notification to request unit 110, and when request unit 110 receives the notification from operating unit 100, request unit 110 generates a keyless signal to output the generated keyless signal to UHF transmitter 104. Upon receiving the keyless signal from request unit 110, UHF transmitter 104 transmits the keyless signal to the outside, that is, on-vehicle device 20B. In this manner, request unit 110 and UHF transmitter 104 request on-vehicle device 20B to unlock the doors with the keyless signal including the rolling code. Request unit 110 then increments the value of the rolling code by “1”, and retains the value of the rolling code thus incremented.

UHF receiver 200 and determination unit 210 in on-vehicle device 20B are similar to those in the first exemplary embodiment. In other words, UHF receiver 200 receives the keyless signal from portable device 10B, and outputs the keyless signal to determination unit 210. Determination unit 210 extracts an ID code and the rolling code from the keyless signal received from UHF receiver 200, and performs pair authentication using the ID code. When the pair authentication succeeds, determination unit 210 determines whether the condition is satisfied or not based on the rolling code and the reference rolling code. The condition is the same as that in the first exemplary embodiment.

Upon determining to unlock the doors, determination unit 210 instructs ECU 52 to unlock door lock mechanism 54. When the door unlocking is determined, or when door lock mechanism 54 is unlocked, determination unit 210 increments the value of the reference rolling code by “1”, and retains the value of the reference rolling code.

When determination unit 210 determines to unlock the doors, notification unit 220 outputs notification for increasing the value of the rolling code to portable device 10B. Notification unit 220 uses a search signal in smart communication for this purpose. Specifically, an authentication command in the search signal includes information indicating the notification. Notification unit 220 outputs the generated search signal to LF transmitter 204. LF transmitter 204 transmits the search signal to portable device 10B.

LF receiver 106 of portable device 10B receives the search signal from on-vehicle device 20B. LF receiver 106 outputs the search signal to reception unit 112B. Reception unit 112B extracts the ID code included in the search signal. Reception unit 112B executes the pair authentication based on an ID code retained in advance and the extracted ID. When the pair authentication fails, a process described below is not executed. On the other hand, the pair authentication succeeds, reception unit 112B extracts information indicating the notification from the search signal. Reception unit 112B outputs the information indicating the notification to instruction unit 120B.

When receiving the information indicating the notification from reception unit 112B, instruction unit 120B instructs on-vehicle device 20B to increase a value of the reference rolling code. Similar to the case of FIG. 4C, at this stage, the value of the reference rolling code retained in determination unit 210 coincides with the value of the rolling code stored in unauthorized device 30. In order not to satisfy the above-described condition, the value of the reference rolling code should be increased to be greater than the value of the rolling code stored in unauthorized device 30.

Instruction unit 120B uses a response signal in the smart communication to instruct on-vehicle device 20B to increase the value of the reference rolling code. Specifically, data in the response signal includes an increased value of the reference rolling code. Note that the data in the response signal may include an amount to be increased of the value of the reference rolling code. The former case corresponds to designation with an absolute value, and the latter case corresponds to designation with a relative value. Note that, in the former case, a value having no relation with a current value of the rolling code and the value of the reference rolling code may be designated. In the latter case, an amount of information for the instruction is smaller than an amount of information for the reference rolling code. On the other hand, when the above-described additional condition is defined, instruction unit 120B may instruct to decrease the value of the reference rolling code such that the value of the reference rolling code becomes small while exceeding the certain range. Instruction unit 120B outputs the generated response signal to UHF transmitter 104. UHF transmitter 104 transmits the response signal to on-vehicle device 20B.

When instruction unit 120B varies the value of the reference rolling code, modification unit 116B accordingly modifies the value of the rolling code in request unit 110. Herein, the value of the rolling code is increased. Note that, when to decrease the value of the reference rolling code is instructed, modification unit 116B may decrease the value of the rolling code in request unit 110. As described above, when only the value of the reference rolling code is increased to make the value of the reference rolling code greater than the value of the rolling code stored in unauthorized device 30, the value of the rolling code retained in portable device 10B does not satisfy the condition. To avoid this situation, the value of the rolling code in portable device 10B is modified so as to match the value of the reference rolling code thus increased.

UHF receiver 200 of on-vehicle device 20B receives the response signal from portable device 10B. UHF receiver 200 outputs the response signal to reception unit 222B. Reception unit 222B extracts the instruction for increasing the value of the reference rolling code from the response signal. This operation corresponds to acceptance of the instruction according to the notification from notification unit 220, and for increasing the reference rolling code, from portable device 10B. Reception unit 222B outputs the instruction for increasing the value of the reference rolling code to modification unit 214B.

Modification unit 214B modifies the value of the reference rolling code in determination unit 210 based on the instruction for increasing the value of the reference rolling code. Herein, the value of the reference rolling code is increased. Note that, when to decrease the value of the reference rolling code is instructed, modification unit 214B may decrease the value of the reference rolling code in determination unit 210.

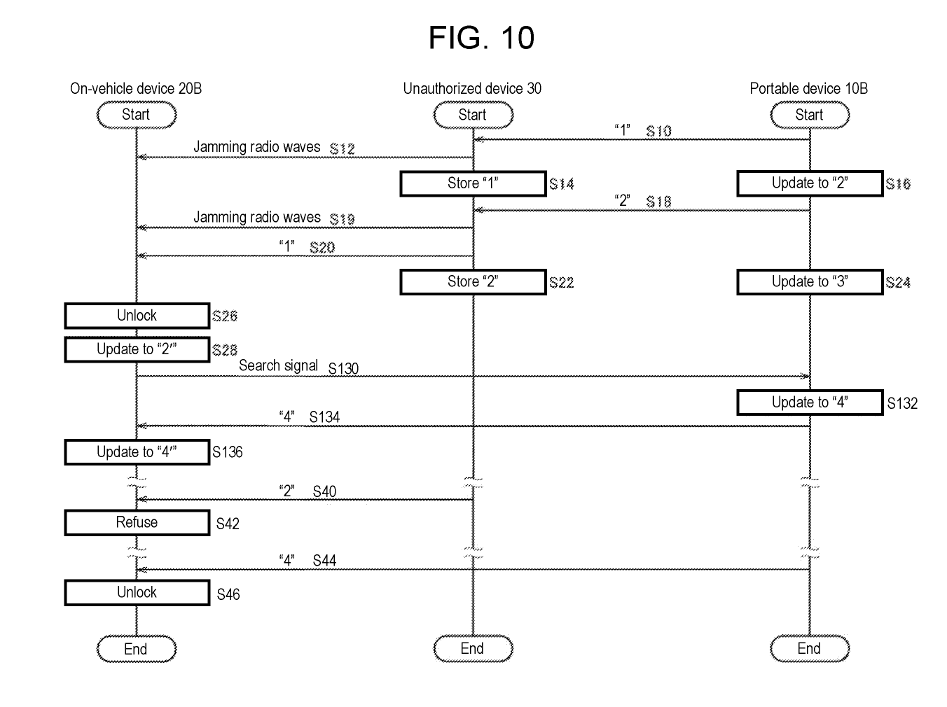

An operation of system 1000B thus configured will be described. FIG. 10 is a sequence diagram illustrating a processing procedure performed by system 1000B. Since S10 to S28 are similar to those in the first exemplary embodiment, processes in S130 and subsequent to S130 will be described.

On-vehicle device 20B determines to unlock the doors (S26), updates the value of the reference rolling code to “2” (S28), and then transmits the search signal to portable device 10B (S130). In connection with the value of the reference rolling code in on-vehicle device 20B being increased to be “4”, portable device 10B updates the value of the rolling code in portable device 10B to “4” (S132). Portable device 10B transmits, to on-vehicle device 20B, the response signal for instructing to increase the value of the reference rolling code to be “4” (S134). Herein, the value of the reference rolling code is increased by “2”, but an increasing amount may be “1”, or may be “3” or more. On-vehicle device 20B updates the value of the reference rolling code to “4” (S136).

Hereinafter, S40 to S46 are the same as those in the first exemplary embodiment. In other words, even when unauthorized device 30 transmits the keyless signal including the value of “2” of the rolling code (S40), since the value of “2” of the rolling code is smaller than “4” of the reference rolling code, on-vehicle device 20B refuses unlocking (S42). On the other hand, portable device 10B transmits the keyless signal including the value of “4” of the rolling code (S44), so that on-vehicle device 20B determines unlocking (S46).

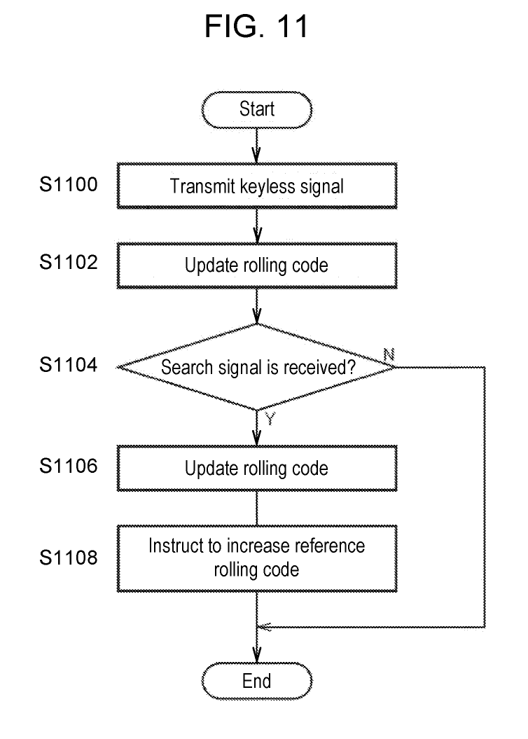

FIG. 11 is a flowchart illustrating a processing procedure performed by portable device 10B. Request unit 110 transmits the keyless signal (S1100), and updates the value of the rolling code (S1102). When reception unit 112B receives the search signal (Y in S1104), modification unit 116B updates the value of the rolling code (S1106). Instruction unit 120B instructs on-vehicle device 20B to increase the value of the reference rolling code (S1108). When reception unit 112B does not receive the search signal (N in S1104), the process is terminated.

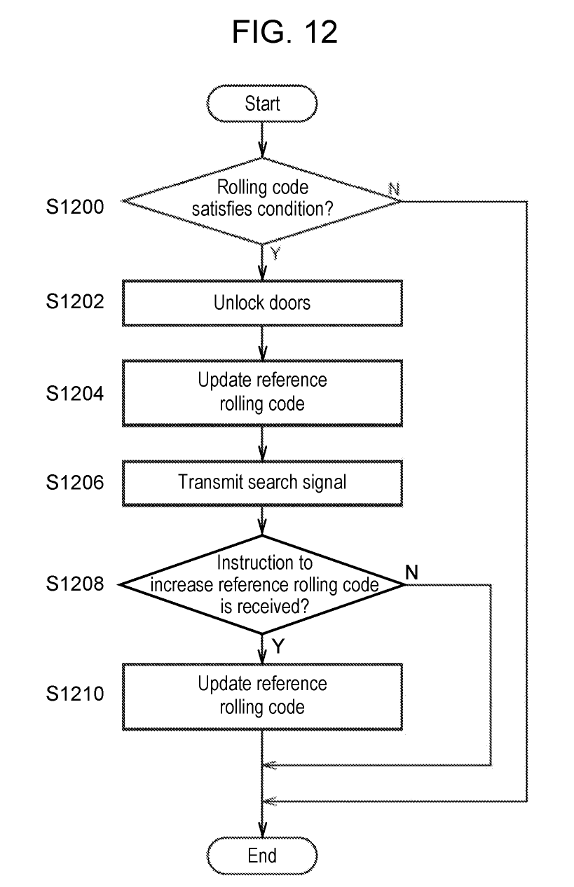

FIG. 12 is a flowchart illustrating a processing procedure performed by on-vehicle device 20B. When the rolling code satisfies the condition (Y in S1200), determination unit 210 determines to unlock the doors (S1202), and updates the value of the reference rolling code (S1204). Notification unit 220 transmits the search signal to portable device 10B (S1206). When receiving the instruction for increasing the value of the reference rolling code from portable device 10B (Y in S1208), modification unit 214B updates the value of the reference rolling code (S1210). When the rolling code does not satisfy the condition (N in S1200), or when the instruction for increasing the value of the reference rolling code is not received from portable device 10B (N in S1208), the process is terminated.

According to the present exemplary embodiment, when on-vehicle device 20B determines to unlock the doors based on the rolling code, portable device 10B instructs on-vehicle device 20B to increase the value of the reference rolling code. Therefore the reference rolling code having a value different from the value of the rolling code stored in unauthorized device 30 is set in on-vehicle device 20B. Since the reference rolling code having the value different from the value of the rolling code stored in unauthorized device 30 is set in on-vehicle device 20B, on-vehicle device 20B can prevent door unlocking even when receiving the value of rolling code stored in unauthorized device 30. Since on-vehicle device 20B increases the value of the rolling code, on-vehicle device 20B can unlock the doors by the rolling code from portable device 10B. These processes can decrease a risk of the roll-jam attack.

Portable device 10B notifies of the value to be increased of reference rolling code. Therefore, the value of the rolling code and the value of the reference rolling code can surely coincide with each other. Alternatively, portable device 10B notifies of the amount to be increased. Therefore, an amount of information to be notified can be suppressed from increasing. According to the instruction from portable device 10B, on-vehicle device 20B increases the value of the reference rolling code, and the value of the rolling code in portable device 10B is increased, whereby the risk of the roll-jam attack can be decreased.

As described above, portable device 10B includes request unit 110, reception unit 112B, modification unit 116B, and instruction unit 120B. Request unit 110 requests on-vehicle device 20B to unlock the doors by transmitting the signal including the rolling code. When on-vehicle device 20B determines to unlock the doors based on the rolling code and the reference rolling code to be collated with the rolling code according to the request from request unit 110, reception unit 112B receives the notification from on-vehicle device 20B. When reception unit 112B receives the notification, modification unit 116B increases the value of the rolling code to be used in request unit 110. When reception unit 112B receives the notification, instruction unit 120B instructs on-vehicle device 20B to increase the value of the reference rolling code. According to the instruction from instruction unit 120B, on-vehicle device 20B increases the value of the reference rolling code.

With this configuration, when on-vehicle device 20B determines to unlock the doors based on the rolling code, portable device 10B instructs on-vehicle device 20B to increase the value of the reference rolling code, and increases the value of the rolling code in portable device 10B, whereby the risk of the roll-jam attack can be decreased.

Instruction unit 120B may notify on-vehicle device 20B of the value to be increased of the reference rolling code. In this case, the value of the rolling code and the value of the reference rolling code can surely coincide with each other.

Instruction unit 120B may notify on-vehicle device 20B of the amount to be increased of the reference rolling code. In this case, the amount to be increased is notified. Therefore, an amount of information to be notified is suppressed from increasing.

On-vehicle device 20B includes determination unit 210, notification unit 220, reception unit 222B, and modification unit 214B. Determination unit 210 determines whether to unlock the doors based on the rolling code from portable device 10B and the reference rolling code to be collated with the rolling code. When determination unit 210 determines to unlock the doors, notification unit 220 outputs the notification to portable device 10B. Reception unit 222B receives, from portable device 10B, the instruction according to the notification from notification unit 220, and for increasing the reference rolling code. Modification unit 214B increases the value of the reference rolling code to be used in determination unit 210 based on the instruction received in reception unit 222B. According to the notification from notification unit 220, portable device 10B increases the value of the rolling code.

With this configuration, on-vehicle device 20B increases the value of the reference rolling code according to the instruction from portable device 10B, and the value of the rolling code in portable device 10B is increased, whereby the risk of the roll-jam attack can be decreased.

System 1000B includes portable device 10B and on-vehicle device 20B. Portable device 10B requests to unlock the door by transmitting the signal including the rolling code. On-vehicle device 20B determines whether to unlock the doors based on the rolling code from portable device 10B and the reference rolling code to be collated with the rolling code. When determining to unlock the doors, on-vehicle device 20B outputs the notification to portable device 10B. Based on the received notification, portable device 10B increases the value of the rolling code, and instructs on-vehicle device 20B to increase the value of the reference rolling code. Based on the received instruction, on-vehicle device 20B increases the value of the reference rolling code.

With this configuration, when on-vehicle device 20B determines to unlock the doors based on the rolling code, portable device 10B instructs the on-vehicle device to increase the value of the reference rolling code, and increases the value of the rolling code in portable device 10B. Therefore, the risk of the roll-jam attack can be decreased.

### Third Exemplary Embodiment

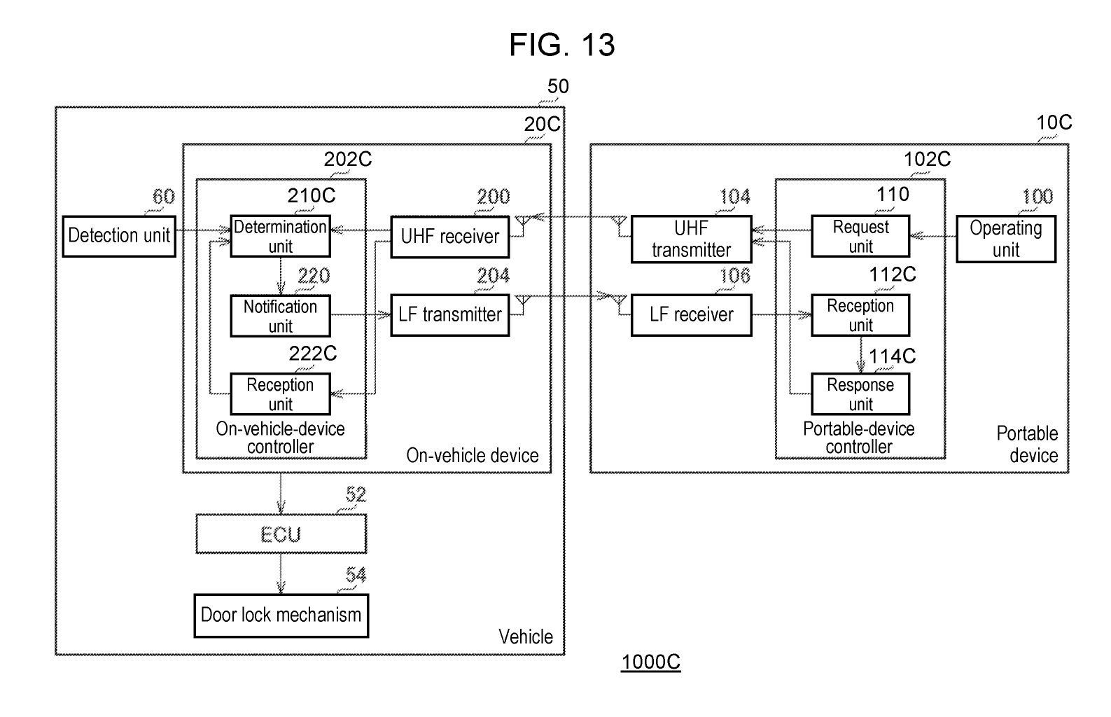

FIG. 13 illustrates a configuration of vehicle wireless communication system (hereinafter, system) 1000C according to a third exemplary embodiment of the present disclosure. System 1000C includes portable device 10C and on-vehicle device 20C.

In the present exemplary embodiment, to decrease a risk of a roll-jam attack, when on-vehicle device 20C unlocks doors by receiving a signal including a rolling code, on-vehicle device 20C performs two-way wireless communication with portable device 10C. When a door knob of a vehicle is touched after the two-way wireless communication is terminated, on-vehicle device 20C continues the door unlocking. In contrast, when the door knob of the vehicle is touched before the two-way wireless communication is terminated, on-vehicle device 20C relocks the doors. This is because it is estimated that the roll-jam attack occurs since the two-way wireless communication is not terminated between an unauthorized device and on-vehicle device 20C.

Portable device 10C includes operating unit 100, portable-device controller (hereinafter, controller) 102C, UHF transmitter 104, and LF receiver 106. Controller 102C includes request unit 110, reception unit 112C, and response unit 114C.

On-vehicle device 20C is mounted on vehicle 50. On-vehicle device 20C includes UHF receiver 200, on-vehicle-device controller (hereinafter, controller) 202C, and LF transmitter 204. Controller 202C includes determination unit 210C, notification unit 220, and reception unit 222C. Vehicle 50 includes ECU 52 and door lock mechanism 54, similar to the first exemplary embodiment, and further includes detection unit 60. Note that detection unit 60 may be included in on-vehicle device 20C.

Operating unit 100, request unit 110, and UHF transmitter 104 in portable device 10C are the same as those in the first exemplary embodiment. In other words, when operating unit 100 is operated, operating unit 100 sends notification to request unit 110, and when request unit 110 receives the notification from operating unit 100, request unit 110 generates a keyless signal to output the generated keyless signal to UHF transmitter 104. Upon receiving the keyless signal from request unit 110, UHF transmitter 104 transmits the keyless signal to the outside, that is, on-vehicle device 20C. In this manner, request unit 110 and UHF transmitter 104 request on-vehicle device 20C to unlock the doors with the keyless signal including the rolling code. Request unit 110 then increments the value of the rolling code by “1”, and retains the value of the rolling code thus incremented.

UHF receiver 200 in on-vehicle device 20C is the same as that in the first exemplary embodiment. Determination unit 210C is the same as determination unit 210 in the first and second exemplary embodiments at a stage of receiving the keyless signal from request unit 110. In other words, UHF receiver 200 receives the keyless signal from portable device 10C, and outputs the keyless signal to determination unit 210C. Determination unit 210C extracts an ID code and the rolling code from the keyless signal received from UHF receiver 200, and performs pair authentication using the ID code. When the pair authentication succeeds, determination unit 210C determines whether the condition is satisfied or not based on the rolling code and the reference rolling code. The condition is the same as that in the first exemplary embodiment.

Upon determining to unlock the doors, determination unit 210C instructs ECU 52 to unlock door lock mechanism 54. When the door unlocking is determined, or when door lock mechanism 54 is unlocked, determination unit 210C increments the value of the reference rolling code by “1”, and retains the value of the reference rolling code.

When determination unit 210C determines to unlock the doors, notification unit 220 uses a search signal in smart communication to output notification to portable device 10C. Specifically, an authentication command in the search signal includes information indicating the notification. Notification unit 220 outputs the generated search signal to LF transmitter 204. LF transmitter 204 transmits the search signal to portable device 10C.

LF receiver 106 of portable device 10C receives the search signal from on-vehicle device 20C. LF receiver 106 outputs the search signal to reception unit 112C. Reception unit 112C extracts the ID code included in the search signal. Reception unit 112C executes the pair authentication based on an ID code retained in advance and the extracted ID. When the pair authentication fails, a process described below is not executed. On the other hand, when the pair authentication succeeds, reception unit 112C extracts the information indicating the notification from the search signal. Reception unit 112C outputs the information indicating the notification to response unit 114C.

Response unit 114C uses a response signal in the smart communication to notify on-vehicle device 20C of a response to the notification received by reception unit 112C. Response unit 114C outputs the response signal to UHF transmitter 104. UHF transmitter 104 transmits the response signal to on-vehicle device 20C.

UHF receiver 200 of on-vehicle device 20C receives the response signal from portable device 10C. UHF receiver 200 outputs the response signal to reception unit 222C. When receiving the response signal from portable device 10C, reception unit 222C notifies determination unit 210C of the reception of the response signal. Detection unit 60 is a sensor that detects that the door knob of vehicle 50 is touched. Detecting that the door knob of vehicle 50 is touched corresponds to detecting an operation for opening the door, that is, detecting an operation performed by another person to board vehicle 50. Detection unit 60 outputs the detection result to determination unit 210C. After receiving the notification from reception unit 222C, that is, when reception unit 222C receives the response signal, if detection unit 60 detects the operation for opening the door, determination unit 210C maintains the determination for unlocking the doors. This allows a user of portable device 10C to board vehicle 50.

In contrast, when a transmission source of the rolling code for unlocking the doors is unauthorized device 30, the smart communication cannot be established between on-vehicle device 20C and unauthorized device 30. Specifically, when determination unit 210C determines to unlock the doors, notification unit 220 and LF transmitter 204 transmit the search signal. On the other hand, unauthorized device 30 that does not support the smart communication cannot receive the search signal from on-vehicle device 20C. Since unauthorized device 30 does not accordingly transmit the response signal, UHF receiver 200 and reception unit 222C do not receive the response signal from unauthorized device 30. Before receiving the notification from reception unit 222C, that is, when reception unit 222C has not received the response signal, if detection unit 60 detects the operation for opening the door, determination unit 210C determines to relock the doors. Determination unit 210C instructs ECU 52 in vehicle 50 to lock door lock mechanism 54.

As described above, when reception unit 222C has not received the response signal, if detection unit 60 detects the operation for opening the door, determination unit 210C determines to relock the doors. Instead of this operation, when reception unit 222C has not received the response signal, determination unit 210C may determine to relock the doors after a lapse of a certain period. Because it can be estimated that unauthorized device 30 transmits the rolling code, also in this case.

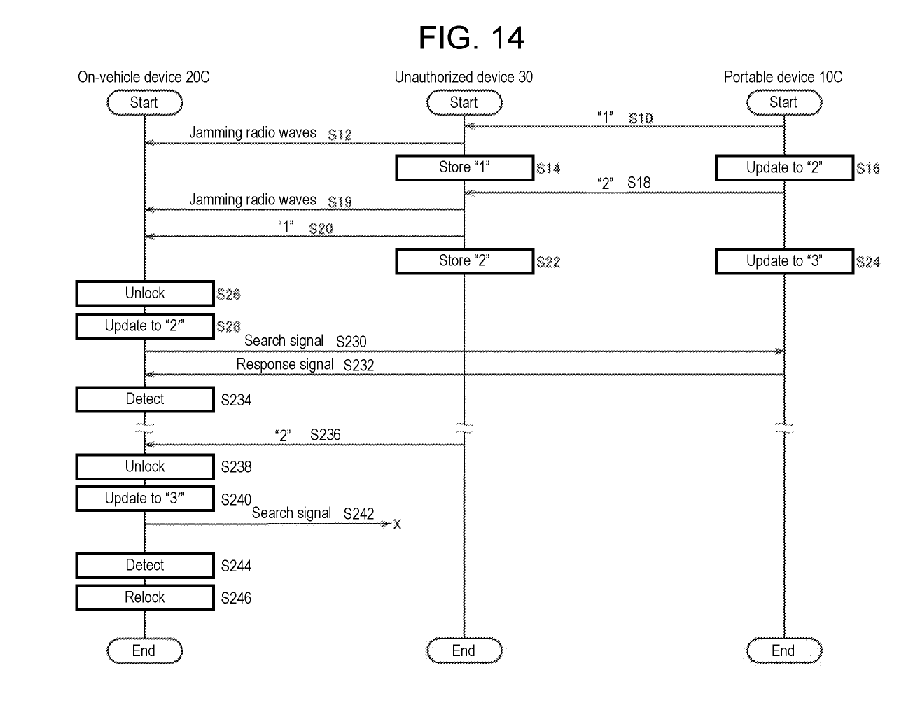

An operation of system 1000C thus configured will be described. FIG. 14 is a sequence diagram illustrating a processing procedure performed by system 1000C. Since S10 to S28 are similar to those in the first exemplary embodiment, processes in S230 and subsequent to S230 will be described.

On-vehicle device 20C determines unlocking (S26), updates the value of the reference rolling code to “2” (S28), and then transmits the search signal to portable device 10C (S230). Portable device 10C transmits the response signal to portable device 10C (S232). Detection unit 60 detects the operation for opening the door (S234).

Unauthorized device 30 transmits the keyless signal including the value of “2” of the rolling code (S236). The value of “2” of the rolling code included in the keyless signal coincides with “2” of the reference rolling code that has been retained, whereby on-vehicle device 20C determines unlocking (S238). On-vehicle device 20C updates the value of the reference rolling code to “3” (S240). On-vehicle device 20C transmits the search signal (S242). However, unauthorized device 30 does not receive the search signal. When detection unit 60 detects the operation for opening the door (S244), on-vehicle device 20C determines to relock the doors (S246).

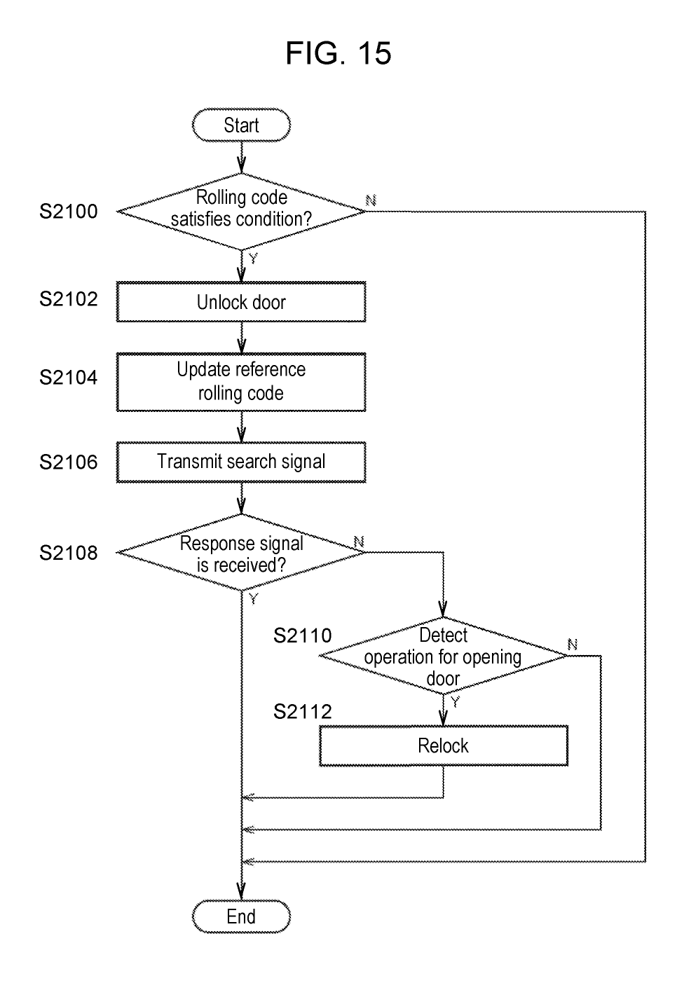

FIG. 15 is a flowchart illustrating a processing procedure performed by on-vehicle device 20C. When the rolling code satisfies the condition (Y in S2100), determination unit 210C determines to unlock the doors (S2102). Further, determination unit 210C updates the value of the reference rolling code (S2104). Notification unit 220 transmits the search signal (S2106). When reception unit 222C receives the response signal (Y in S2108), the process is terminated. In contrast, when reception unit 222C does not receive the response signal (N in S2108), if detection unit 60 detects the operation for opening the door (Y in S2110), determination unit 210C determines to relock the doors (S2112). When detection unit 60 does not detect the operation for opening the door (N in S2110), the process is terminated. When the rolling code does not satisfy the condition (N in S2100), the process is terminated.

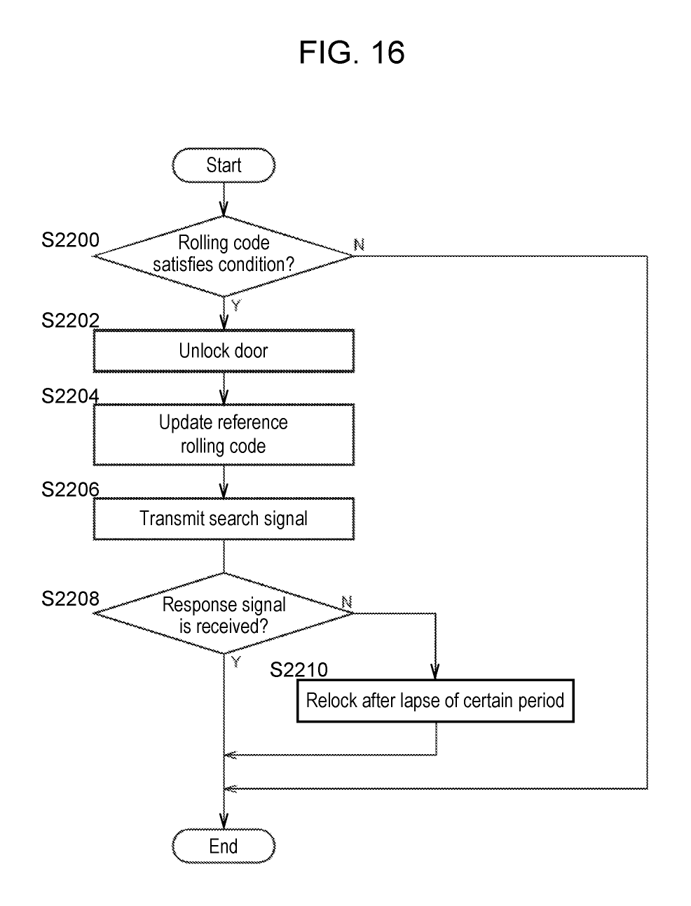

FIG. 16 is a flowchart illustrating another processing procedure performed by on-vehicle device 20C. When the rolling code satisfies the condition (Y in S2200), determination unit 210C determines to unlock the doors (S2202). Further, determination unit 210C updates the value of the reference rolling code (S2204). Notification unit 220 transmits the search signal (S2206). When reception unit 222C receives the response signal (Y in S2208), the process is terminated. In contrast, when reception unit 222C does not receive the response signal (N in S2208), determination unit 210C determines to relock the doors after a lapse of a certain period (S2210). When the rolling code does not satisfy the condition (N in S2200), the process is terminated.

According to the present exemplary embodiment, when on-vehicle device 20C has not received the response signal, if the operation for opening the door is detected, relocking the doors is determined. Accordingly, in a case of an unlocking operation using unauthorized device 30, the doors can be locked. Further, in the case of the unlocking operation using unauthorized device 30, the doors are locked, whereby the risk of the roll-jam attack can be decreased. When the response signal is received, if the operation for opening the door is detected, the determination for unlocking the doors is maintained. This allows the user of portable device 10C to board vehicle 50. When the response signal has not been received, if a certain period is elapsed, relocking the doors is determined. This allows the doors to be locked in the case of the unlocking operation using the unauthorized device.

As described above, on-vehicle device 20C includes determination unit 210C, a transmitter, and a receiver. The transmitter is configured with LF transmitter 204 and notification unit 220. The receiver is configured with UHF receiver 200 and reception unit 222C. In other words, on-vehicle device 20C includes determination unit 210C, notification unit 220, and reception unit 222C. Determination unit 210C determines whether to unlock the doors based on the rolling code from portable device 10C and the reference rolling code to be collated with the rolling code. When determination unit 210C determines to unlock the doors, the transmitter (notification unit 220) transmits the search signal to portable device 10C. The receiver (reception unit 222C) receives the response signal from portable device 10C as a response to the search signal transmitted from the transmitter. When the receiver has not received the response signal, if the operation for opening the door is detected, determination unit 210C determines to relock the doors.

With this configuration, when reception unit 222C has not received the response signal, if the operation for opening the door is detected, determination unit 210C determines to relock the doors, whereby the risk of the roll-jam attack can be decreased.

When reception unit 222C receives the response signal, if the operation for opening the door is detected, determination unit 210C may maintain the determination of unlocking the doors. In this case, when reception unit 222C receives the response signal, if the operation for opening the door is detected, the determination of unlocking the doors is maintained. This allows the user of portable device 10C to board vehicle 50.

System 1000C includes portable device 10C and on-vehicle device 20C. Portable device 10C requests to unlock the door by transmitting the signal including the rolling code. On-vehicle device 20C determines whether to unlock the doors based on the rolling code from the portable device and the reference rolling code to be collated with the rolling code. When determining to unlock the doors, on-vehicle device 20C transmits the search signal to portable device 10C. Portable device 10C transmits the response signal to on-vehicle device 20C as the response to the search signal. When the response signal has not been received, if the operation for opening the door is detected, on-vehicle device 20C determines to relock the doors.

With this configuration, when on-vehicle device 20C has not received the response signal, if the operation for opening the door is detected, on-vehicle device 20C determines to relock the doors, whereby the risk of the roll-jam attack can be decreased.

Various exemplary embodiments of the present disclosure have been described above. It will be understood by those skilled in the art that these exemplary embodiments are merely examples, other exemplary modifications in which components and/or processes of the exemplary embodiments are variously combined are possible, and the other exemplary modifications are still fall within the scope of the present disclosure.

The configuration illustrated in the block diagram in each exemplary embodiment can be achieved with a central processing unit (CPU), a memory, large scale integration (LSI), and the like of any computer in terms of hardware or with a program loaded on the memory in terms of software. Each of FIG. 5, FIG. 9, and FIG. 13 depicts functional blocks implemented by coordination of those configurations. Alternatively, each block may be implemented by a dedicated circuit. In this manner, it will be understood by those skilled in the art that these functional blocks can be achieved in various forms by the hardware alone or by combinations of the hardware and the software.

In each exemplary embodiment, the signal including the rolling code may be transmitted through the one-way communication from the portable device to the on-vehicle device, and the instruction to the portable device and the notification to the on-vehicle device may be transmitted through the two-way communication between the portable device and the on-vehicle device. In this case, the two-way communication is combined with the one-way communication, so that the information can be exchanged between the portable device and the on-vehicle device.

UHF transmitter 104 and UHF receiver 200 use the UHF signal. However, the present disclosure is not limited this configuration. For example, a signal other than the UHF signal and of a frequency higher than the LF may be used. This modification can improve the degree of freedom in the configuration.

In each exemplary embodiment, the smart communication is performed between the portable device and the on-vehicle device. However, the present disclosure is not limited to this configuration. Instead of the smart communication performed between the portable device and the on-vehicle device, wireless communication for an immobilizer that is a collation system for an electronic key may be used, for example. Even with such wireless communication, information to be transmitted is the same as that in each exemplary embodiment. This modification can improve the degree of freedom in the configuration.

In each exemplary embodiment, encryption may further be performed on the rolling code included in the signal transmitted from the portable device. In the roll-jam attack, an encrypted rolling code is copied as an encrypted text, and the encrypted text is transmitted without modification at a next timing. Therefore, the encryption itself cannot be effective against the roll-jam attack. However, this can prevent different illegal boarding in which the rolling code itself is analyzed to unlock the doors. Hence, security in the keyless communication can be improved.

### INDUSTRIAL APPLICABILITY

The present disclosure is effective for reducing a risk of a roll-jam attack for door unlocking of a vehicle or the like.

### REFERENCE MARKS IN THE DRAWINGS

10, 10A, 10B 10C portable device

20, 20A, 20B, 20C on-vehicle device

50, 150 vehicle

52 ECU

54 door lock mechanism

60 detection unit

100 operating unit

102A, 102B, 102C portable-device controller (controller)

104 UHF transmitter

106 LF receiver

110 request unit

112A, 112B, 112C reception unit

114A, 114C response unit

116A, 116B modification unit

120B instruction unit

200 UHF receiver

202A, 202B, 202C on-vehicle-device controller (controller)

204 LF transmitter

210, 210C determination unit

212 instruction unit

214A, 214B modification unit

220 notification unit

222B, 222C reception unit

1000A, 1000B, 1000C vehicle wireless communication system (system)

1. An on-vehicle device comprising:
a determination unit that determines whether to unlock a door based on a rolling code from a portable device and a reference rolling code to be collated with the rolling code;
an instruction unit that instructs the portable device to increase a value of the rolling code, when the determination unit determines to unlock the door; and
a modification unit that increases a value of the reference rolling code to be used in the determination unit, when the portable device accepts the instruction from the instruction unit.

2. The on-vehicle device according to claim 1, wherein the instruction unit notifies the portable device of a value to be increased of the rolling code.

3. The on-vehicle device according to claim 1, wherein the instruction unit notifies the portable device of an amount to be increased of the value of the rolling code.

4. A portable device comprising:
a request unit that requests an on-vehicle device to unlock a door by transmitting a signal including a rolling code;
a reception unit that receives an instruction for increasing a value of the rolling code from the on-vehicle device, when the on-vehicle device determines to unlock the door according to the request from the request unit; and
a response unit that increases the value of the rolling code based on the instruction received in the reception unit and notifies the on-vehicle device of acceptance of the instruction.

5. A vehicle wireless communication system comprising:
a portable device that requests to unlock a door by transmitting a signal including a rolling code; and
an on-vehicle device that determines whether to unlock the door based on the rolling code from the portable device and a reference rolling code to be collated with the rolling code,
wherein
the on-vehicle device instructs the portable device to increase a value of the rolling code, when the on-vehicle device determines to unlock the door,
the portable device increases the value of the rolling code based on the received instruction, and notifies the on-vehicle device of acceptance of the instruction, and
the on-vehicle device increases a value of the reference rolling code, when the portable device accepts the instruction.

6. The vehicle wireless communication system according to claim 5,
wherein
the signal including the rolling code is transmitted through one-way communication from the portable device to the on-vehicle device, and
the instruction to the portable device and the notification to the on-vehicle device are transmitted through two-way communication between the portable device and the on-vehicle device.

7. A portable device comprising:
a request unit that requests an on-vehicle device to unlock a door by transmitting a signal including a rolling code;
a reception unit that receives notification from the on-vehicle device, when the on-vehicle device determines to unlock the door according to the request from the request unit;
a modification unit that increases a value of the rolling code to be used in the request unit, when the reception unit receives the notification; and
an instruction unit that instructs the on-vehicle device to increase a value of a reference rolling code to be collated with the rolling code, when the reception unit receives the notification.

8. The portable device according to claim 7, wherein the instruction unit notifies the on-vehicle device of a value to be increased of the reference rolling code.

9. The portable device according to claim 7, wherein the instruction unit notifies the on-vehicle device of an amount to be increased of the value of the reference rolling code.

10. An on-vehicle device comprising:
a determination unit that determines whether to unlock a door based on a rolling code from a portable device and a reference rolling code to be collated with the rolling code;
a notification unit that outputs notification for increasing a value of the rolling code to the portable device, when the determination unit determines to unlock the door;
a reception unit that receives, from the portable device, an instruction according to the notification from the notification unit, and for increasing the reference rolling code; and
a modification unit that increases a value of the reference rolling code based on the instruction received by the reception unit.

11. A vehicle wireless communication system comprising:
a portable device that requests to unlock a door by transmitting a signal including a rolling code; and
an on-vehicle device that determines whether to unlock the door based on the rolling code from the portable device and a reference rolling code to be collated with the rolling code,
wherein
the on-vehicle device outputs notification to the portable device when the on-vehicle device determines to unlock the door,
the portable device increases a value of the rolling code based on the received notification, and instructs the on-vehicle device to increase a value of the reference rolling code, and
the on-vehicle device increases the value of the reference rolling code based on the received instruction.

12. The vehicle wireless communication system according to claim 11,
wherein
the signal including the rolling code is transmitted through one-way communication from the portable device to the on-vehicle device, and
the notification to the portable device and the instruction to the on-vehicle device are transmitted through two-way communication between the portable device and the on-vehicle device.

13. An on-vehicle device comprising:
a determination unit that determines whether to unlock a door based on a rolling code from a portable device and a reference rolling code to be collated with the rolling code;
a transmitter that transmits a search signal to the portable device, when the determination unit determines to unlock the door; and
a receiver that receives a response signal from the portable device as a response to the search signal transmitted from the transmitter,
wherein
when the receiver has not received the response signal, if an operation for opening the door is detected, the determination unit determines to relock the door.

14. The on-vehicle device according to claim 13,
wherein when the receiver has received the response signal, if the operation for opening the door is detected, the determination unit maintains the determination to unlock the door.

15. The on-vehicle device according to claim 13, further comprising
a detection unit that detects the operation for opening the door, and outputs a detection result to the determination unit.

16. A vehicle wireless communication system comprising:
a portable device that requests to unlock a door by transmitting a signal including a rolling code; and
an on-vehicle device that determines whether to unlock the door based on the rolling code from the portable device and a reference rolling code to be collated with the rolling code,
wherein
the on-vehicle device transmits a search signal to the portable device, when the on-vehicle device determines to unlock the door,
the portable device transmits a response signal to the on-vehicle device as a response to the search signal, and
when the response signal has not been received, if an operation for opening the door is detected, the on-vehicle device determines to relock the door.

17. The vehicle wireless communication system according to claim 16,
wherein
the signal including the rolling code is transmitted through one-way communication from the portable device to the on-vehicle device, and
the search signal to the portable device and the response signal to the on-vehicle device are transmitted through two-way communication between the portable device and the on-vehicle device.
